(19) United States
(12) Patent Application Publication
(10) Pub. No.: US 2011/0153696 A1
(43) Pub. Date: Jun. 23, 2011

(54) Data Storage Aggregation on a Mobile Device

(76) Inventors: Anurekh Saxena, Cambridge, MA (US); Tejasvi Aswathanarayna, Malden, MA (US); Chukwuezugo Nwosu, Pittsburgh, PA (US)

(21) Appl. No.: 12/972,458

(22) Filed: Dec. 18, 2010

Related U.S. Application Data
(60) Provisional application No. 61/287,930, filed on Dec. 18, 2009.

(51) Int. Cl. G06F 17/30

(52) U.S. Cl. 707/827; 707/E17.01

(57) ABSTRACT

Software, running on a mobile platform, aggregates file structures from one or more remote file servers into a virtual, unified file structure. The local storage of the mobile platform is also containing in the virtual unified file structure. The virtual, unified file structure is presented to a user as though the entire file structure were local to the mobile computing device.

### RELATED APPLICATIONS

This application claims the benefit of U.S. provisional patent application Ser. No. 61/287,930, filed Dec. 18, 2009.

### FIELD OF THE INVENTION

This application is related to file systems, and, in particular, to remotely located file systems which are accessible over a TCP/IP connection, and to the problems inherent in organizing and presenting coherent views of the files contained in multiple file systems when accessed by a single computer or mobile device.

### BACKGROUND OF THE INVENTION

The term “cloud computing” refers to the delivery of computing services via an internet connection. The term “cloud” in this context is a metaphor for the internet, and services, such as file storage or archiving, the running of applications, or the delivery of a service, such as email, is provided via an internet connection and accessed through a program such as a web browser or a customized application. This model allows the delivery of computing services using a utility model, akin to the delivery of electricity via the electrical grid or television programming via a cable or satellite infrastructure.

Several comprehensive cloud computing solutions are currently available, including, for example, Microsoft's WindowsLive service, Apple's MobileMe service and a suite of services offered by Google. One aspect of the cloud computing concept is the on-line storage of users' personal files, including, for example, data files, documents, spreadsheets, photographs, music files, video files, or any other type of file typically created or used by a user that would otherwise be stored in the personal file storage area on a personal computer.

As examples of the file storage aspect of the cloud computing model, WindowsLive includes a service called SkyDrive, MobileMe includes a service called iDisk and Google offers Google Docs. These services provide not only the ability to offload personal file storage needs to an internet-based solution, but the ability to access those files, not only from one's personal computer, but from any computer or mobile device having an internet connection, regardless of location. Indeed, once the user is remote from his home-based personal computer, that computer becomes part of the “cloud” to which the user has access, and any personal files stored there may become “cloud accessible”.

One difficulty inherent in the cloud computing model is the ability to locate and organize files which may be spread out over several actual locations and accessible using separate facilities or separate internet connections. For example, a person having files spread out over an internet accessible personal computer, a SkyDrive and an iDisk may have difficulty remembering which of those contains a particular file and how to access that file.

It would therefore be desirable to provide a unified presentation of files contained in multiple physical location in the cloud. Preferably, the unified presentation would give the illusion that all of the files are located in a single hierarchical file structure, instead of in multiple, diverse file structures. It would also be desirable, both for convenience and security reasons, that this unified file structure be created in a central location or single point of access, such as on a mobile device, but available in multiple locations, such as on a personal computing device, where the single point of access can act as a server of the unified file structure. As such, the single point of access becomes a part of the cloud itself, accessible by other clients.

### SUMMARY OF THE INVENTION

The present invention addresses the problems outlined above by providing a unified interface to a virtual file structure through a protocol abstraction layer that aggregates disparate, fragmented data storage into the virtual, unified file structure, allowing a homogeneous file system for a user in a heterogeneous environment. Access to the virtual, unified file structure is provided through an internet service, preferably running on a mobile, web-connected device, a web-browser, a media player or other means, which may directly provide a user interface to the virtual, unified file structure, or which may serve the virtual file structure to another device. Preferably, to the user, the fact that the virtual file structure consists of an aggregation of several separate physical file structures in not apparent from interacting with the virtual file structure.

One difficulty encountered when unifying disparate sources of files is that different storage solutions will have different file sharing and access protocols. The solution provided by the present invention is to provide a unified interface to the virtual file structure through a protocol abstraction layer that aggregates the disparate, fragmented storage. Therefore, the preferred embodiment of the present invention provides a single common interface to several different file access protocols.

### BRIEF DESCRIPTION OF THE DRAWINGS

FIG. 1 is a block diagram illustrating an architecture of data storage aggregation on a mobile device in one exemplary embodiment of the present invention;

FIG. 2 is a flow diagram illustrating a method for data storage aggregation on a mobile device in another exemplary embodiment of the present invention; and

FIG. 3 is a flow diagram illustrating a method for data storage aggregation on a mobile device in a yet another exemplary embodiment of the present invention.

### DETAILED DESCRIPTION OF THE INVENTION

The following detailed description is of the best currently contemplated modes of carrying out exemplary embodiments of the invention. The invention is not meant to be limited to these exemplary embodiments and they are provided solely for the purpose of illustrating the general principles of the invention, as the scope of the invention is best defined by the appended claims.

Note that the invention is described in its preferred embodiment, that is, as running on a mobile device, such as an iPhone or a device running the Android operating system. However, in practice, the software comprising the invention could be running on any computing platform, including for example, a laptop computer, a desktop computer or a tablet computer.

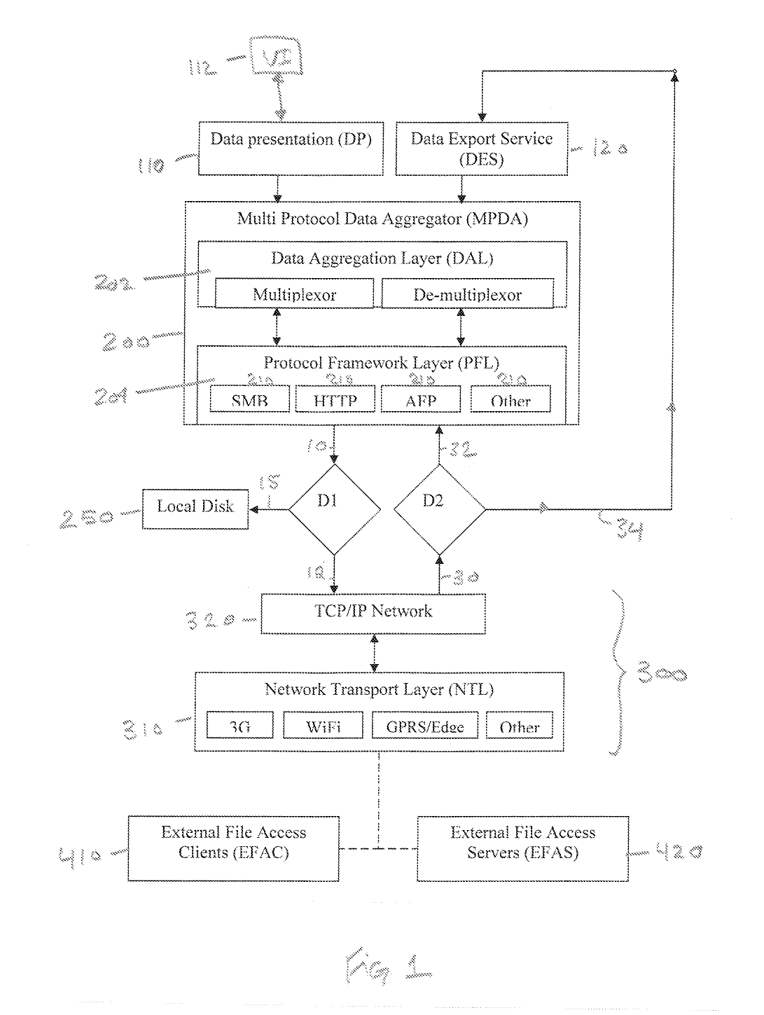

In reference to FIG. 1, there are two modes of operation for the invention. In the first aspect of the invention, the virtual file structure is presented to the user directly on the mobile computing platform through data presentation module 110, which allows the user to see files from multiple sources, including both remote and local sources, in a virtual, unified hierarchy. Ideally, user interface 112 may be written and layered upon data presentation module 110 to show the file structure in a manner determined by the designer of the user interface, for example, utilizing specific icons for specific types of files, sorting the files using various criteria, or providing a user interface specific to a particular computing platform.

Data presentation module 110 provides a common set of services available for all of the files imported from the different protocols and aggregated by the lower layers of the software, which will be discussed later. Data presentation module 110 also presents special services for specific files based upon the type of file and may map user inputs to specific service calls to the underlying layers.

In the second aspect of the invention, the mobile device running the software shown in FIG. 1 may be utilized as a server to serve the virtual unified file structure to an external device via a TCP/IP connection. This aspect of the invention is provided by data export service module 120. Data export service 120 may expose an HTTP server, a Server Message Block (SMB) server or any other type of server that may provide file access to remote clients. As such, the user can be sitting at another computer and reference the mobile device from that computer to see the virtual unified file structure and access files in that structure.

One advantage of this aspect of the invention is that the security protocols necessary to access the multiple sources of files are aggregated in the mobile device and are not exposed to the eventual client to which the virtual unified file structure is being exported. As such, in this mode of operation the mobile device running the software in FIG. 1 becomes part of the cloud computing solution from the point of view of the client, accessible with a single security access protocol.

The multi protocol data aggregator 200 does the work of unifying the diverse file structures into one unified virtual file structure. Multi-protocol data aggregator 200 is composed of two components, data aggregation layer 202 and protocol framework layer 204. Protocol framework layer 204 provides the framework for multiple protocol drivers 210 to plug into a unified file access model. It defines a set of core file access services that are implemented by all supported protocols while providing interfaces for special services exported by individual protocols. Protocol framework layer 204 will be accessing files that are coming from many different sources, for example, cloud services that are running SMB or HTTP protocols, local storage, or any one of a number of other file access protocols, labeled as 210 in FIG. 1. Protocol framework layer 204 provides a unified set of files access services to the upper layers of the software and is able to resolve differences between this unified set of file access services and the different actual access protocols 210 used by the various sources of the files, to provide the unified application programming interface to the layer above it.

Data aggregation layer 202 provides multiplexing and de-multiplexing of services for the file access requests that it receives from the data presentation module and data export modules 110 and 120 respectfully. This layer may be required to do protocol emulation when the storage container containing the file for which the request is received is accessed through a different access protocol. Because the semantics between the different file access protocols are different, the data aggregation layer is required to resolve those differences in semantics.

Another function performed by data aggregation layer 202 is to hide the multiple sources of the files and aggregate all the files into a virtual unified file structure.

It often may be required that multi protocol data aggregator 200 emulate protocols when the file structure on an external file access server 420 may be accessed through a different access protocol. For example, if the user has requested to read part of a file residing in a server that may not support reading such a file, multi protocol data aggregator 200 may ask protocol framework layer 204 to download the entire file to the mobile device and provide the user the requested data by reading from the downloaded file.

More specifically, multi protocol data aggregator 200 may first attempt to establish a connection with the server. If the user had specified a protocol to use, multi protocol data aggregator 200 might use that protocol; otherwise multi protocol data aggregator 200 may attempt to detect the protocol that may be used to connect.

Multi protocol data aggregator 200 also tracks access information and priority for different sources of files. When accessing files which may be stored on multiple file servers, multi protocol data aggregator 200 may select a protocol that has the highest priority. The priorities may be static, defined by the user, or may be determined dynamically from a set of properties/metrics. For example, the user may assign a higher priority for a particular file server that does not charge to transfer files and a lower priority to one that does charge. Multi protocol data aggregator 200 may also assign priorities to file servers based on various metrics, such as the protocol the server is using (giving higher priority to protocols that allow reading of segments of a file, for example). Multi protocol data aggregator 200 also maintains a dynamic priority for file servers based on speed, availability and other properties. In addition, the protocol framework layer 204 may update multi protocol data aggregator 200 regarding quality of service issues with respect to various file servers. In general multi protocol data aggregator 200 may use one or a combination of these priorities to select the file server that a file is stored on or read from.

Additionally, multi protocol data aggregator 200 maintains a database of file checksums and the servers they are available from. If the multi protocol data aggregator 200 does not find a file locally, it checks other servers for which it has a checksum for the file and services the request from that server, based on priority.

The user may now access files on all the servers and perform normal file-related functions on any of the external file access servers 420. These functions include, but may not be limited to browsing a directory structure, viewing files that may be supported by a mobile platform, transferring files from one server to another, managing files and folders (creating, deleting, renaming, moving), playing and streaming media files (movies, music), downloading files from the server to a mobile device, e-mailing files as attachments using existing e-mail accounts, faxing files using fax over internet protocol (FoIP) service, printing files, downloading e-mail attachments to any of the servers and uploading photos to social networking sites.

Note that to set up the external file access servers 420 that may be access by the mobile device, users may be required to set up one or more servers by providing multi protocol data aggregator 200 some or all of the following information: a host name or an IP address of a remote server; a port and a protocol that the multi protocol data aggregator 200 may use to connect to the server; and information needed to authenticate with the server. Alternatively, multi protocol data aggregator 200 may try to discover the servers on the local wireless network, in which case. the users may not need to provide the host name or IP address of the server. Preferably, users will have to provide information for a particular server only once. Multi protocol data aggregator 200 may store the information it needs to connect to a remote server in a local database on the mobile device.

Regardless of the actual architecture of the multi-protocol data aggregator 200, this module is required to perform at least the following functions:
present a unified application programming interface for accessing and manipulating file structures and files;
resolve semantic differences between that programming interface and the different access protocols (i.e., SMB, HTTP, etc.);
access disparate file servers to obtain file structures contained therein;
organize the disparate file structures into a virtual unified file structure and allow access to that file structure; and
allow users to request operations on the files and folders (i.e., read, write, copy, move, etc.) in the virtual file structure, and be able to access the actual files via the unified application programming interface.

Referring back to FIG. 1, path 10 out of multi protocol data aggregator 200 leads to decision point D1. Decision point D1 determines if the file structure or files being requested are available locally on local disk 250 or whether they must be accessed over the network. If they must be accessed over the network, a request in a specific format (i.e., SMB, HTTP, etc.) is sent, via path 12, to the remote file server as a TCP/IP packet via TCP/IP stack 300, consisting of TCP/IP network 320 and a network transport layer 310.

When a request is being made in accordance with the first aspect of the invention, that is, a file is being requested by a user on the mobile device, the request originates in data presentation layer 110 and migrates through the multi protocol data aggregator 200, which it is transformed into a request using a particular access protocol. This request flows down through the TCP/IP stack 300, where it is packaged into a TCP/IP packet and sent via the internet to an external file access server 420.

When a request is being made in accordance with the second aspect of the invention, that is, the mobile device is acting as a server of the virtual, unified file structure, the request originates at an external file access client 410 (for example, a web browser, a file browser, a media player, etc.) via a received TCP/IP packet. The request will migrate up the TCP/IP stack 300 to decision point D2 via path 30. At this point, the software is unaware if the data received at decision point D2 is a request for remote access to the virtual file structure, in which case it is routed, via path 20 to data export service layer 120, or if it is a response to a previous request which has migrated down via path 10 from multi protocol data aggregator 200, in which case the data will be sent via path 32, back to multi protocol data aggregator 200. Data export service layer 120 takes incoming request via path 20 and makes a request to multi protocol data aggregator 200. The request is fulfilled in a manner similar to a request from a local user through the data presentation module 110, as described above in accordance with the first aspect of the invention.

Regardless of where the request originates, a request entering the multi protocol data aggregator 200 is de-multiplexed into several requests for different file access services 210, based on which remote server need be accessed and will be sent to different external file access servers 420.

When an external file access client 410 makes a request to the data export service layer 120, the external file access client 410 will view the virtual unified file structures as though all the files were present on the mobile platform, even those files may have been collected from multiple external file access servers 420.

In an addition aspect of the invention, the secure information (i.e., passwords, encrypted keys, etc.) necessary to access the files on a multiple external file servers 420 are not required to be known to the external file access client 410. The external file access client 410 need only provide the security information necessary to send a request to the data export service 120. The knowledge of the security required for accessing multiple external file access file servers 420 is contained in the multi protocol data aggregator 200.

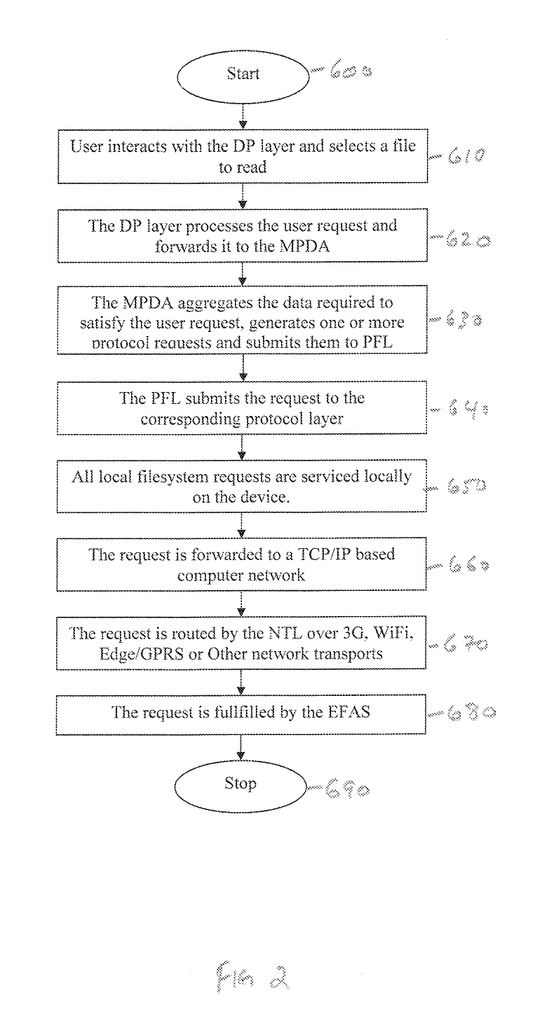

FIG. 2 is a flow chart showing the steps necessary to access the virtual unified file structure as a user on computing platform. In other words, in accordance with the first aspect of the invention, where the request is coming through data presentation module 100 and it's being presented to the user via user locally running user interface 112. The process starts at 600 and, at 610 the user makes a request for a particular file to be read utilizing user interface 112 and a data presentation module 110. At 620 the request is forwarded to the multi protocol data aggregator 200. The data aggregation layer 202, at 630, decides what is required to satisfy the user request and generates one or more protocol requests to the protocol framework layer 204. Protocol framework layer 204, at 640, submits each request via the corresponding access protocol 210. At 650, it is decided if the request may be serviced by the local file system, that is, the file requested is stored on local disk 250. Otherwise, at 660, the request is forwarded via the TCP/IP stack to the computer network and ultimately to the proper external file access server 420. Network transfer layer 310 is responsible for routing the request generated by TCP/IP network 320 via an appropriate transfer protocol (i.e., 3G, WiFi, etc.) at 670. At 680, the request is fulfilled by the external file access server 420 and the data will be returned via one or more TCP/IP packets, and will flow up through TCP/IP stack 300, where it will be aggregated by the data aggregation layer 202 and incorporated into the virtual, unified file system and will be presented to the user via data presentation module 110 and user interface 112. The process stops at 690.

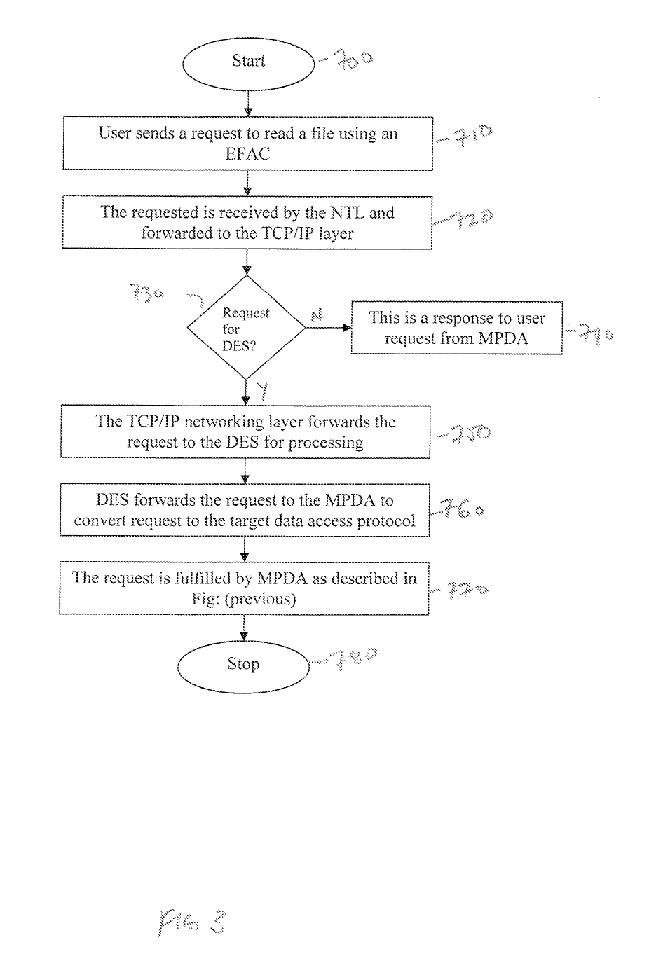

FIG. 3 shows the second aspect of the invention wherein incoming requests from external file access clients 410 are received via the network transport layer 310. The process starts at 700 and, at 710 a request is received from an external file access client 410 via the network transport layer 310. Requests or messages received by network transport layer 310 are one of two types. They are either a request from an external file access client 410 for a DES service, or they are response to a request which was previously made through multiprotocol data aggregator 200. At 730, a determination is made of which type of communication has been received by network transport layer 310. If it is a request for a DES from an external file access client 410, the process proceeds to 750. However, if it is a response to a previous request made through the multiprotocol data aggregator 200, then the previous request is satisfied at 740. However, if the message is a request for DES 120, the request is routed, at 750, via path 20 to the Data export service layer 120. Data export service layer 120 then forwards the a request to the multiprotocol data aggregator to convert the request to a target data access protocol for processing by an external file access server 420. The request is fulfilled by multi protocol data aggregator 202 as described in the process of FIG. 2 starting at 630.

The novelty of the invention lies in the multi protocol data aggregator 200 which is able to both resolve the differences between various protocols 210 and present a unified file access protocol at the edge of the protocol framework layer 204 and to aggregate file structures received from multiple external file access servers 420 into a single virtual hierarchical file structure by data aggregation layer 202 for presentation to a local user via the data presentation module 110 or to be served to an external file access client 410 via the data export service layer 120. In addition the multi protocol data aggregator 200 is able to integrate the local storage 250 of the computing platform into the virtual unified file structure. The multi protocol data aggregator 200 provides all the normal operations for files stored remotely, such as reading, writing, modifying, moving, streaming, etc., that would normally be available for files stored locally. Multi protocol data aggregator 200 also solves the problem of security regarding requests coming in through the data export service layer 120 from external access clients 410. As previously stated, the external file access clients need not know the security access information for every external file access server 420 and, in fact, ideally may not even be aware that files presented in the virtual unified file structure come from multiple external file access servers 420. With respect to the external file access client 410, the file structure presented in response to requests looks as though it resides on the mobile device

As previously stated, the invention has been described in terms of a mobile computing platform such as a smart phone or other tablet device such as a iPad. However, there is no reason that the multi protocol data aggregator 200 could not be installed on a stationery platform and utilized in the same manner. In such case it is likely that the user interface 112 would be different than one would have on a mobile device.

It should also be obvious to one who is skilled in the art that the architectural organization of the multiprotocol data aggregator is only an exemplary embodiment and that many other different configurations could exist providing the functionality described above. The novelty of the invention lies in the functions performed by multi protocol data aggregator 200 and not in its architectural organization. As a result, some claims are provided in terms of functionality provided by the software and not in terms of actual discrete modules where the functions are provided, and the invention is not meant to be limited to the architecture shown in FIG. 1.

We claim:

1. A system for aggregating file structures and files from a plurality of file servers comprising:
a computing platform;
software, installed on said computing platform, said software performing the functions of:
reading one or more file structures from local or remote file servers;
aggregating said one or more file structures into a virtual, unified file structure; and
presenting said virtual, unified file structure to a user.

2. The system of claim 1 wherein said software further performs the functions of:
receiving requests, via said set of core file functions, for manipulation of said virtual unified file structure or for files contained therein;
determining which local or remote file servers must be accessed to fulfill said requests; and
sending said requests, via an internet connection, to said local or remote file servers.

3. The system of claim 2 wherein said software further performs the functions of:
providing a server function, for handling requests from remote clients for access to said virtual, unified file structure; and
receiving requests, via an internet connection, for access to said virtual, unified file structure.

4. The system of claim 2 wherein the function of determining which local or remote file servers must be accessed includes determining a priority between two or more potential file servers capable of fulfilling said request.

5. The system of claim 2 wherein said virtual, unified file system is presented to a user through a user interface as a file structure stored on a local storage device.

6. The system of claim 2 wherein said software further provides a storage function for storing access information for said one or more remote file servers.

7. The system of claim 2 wherein said software further provides a storage function for storing checksums for files which have been previously accessed from one or more local or remote file servers.

8. The system of claim 2 wherein said software further provides a storage function for storing priority information for remote file servers.

9. The system of claim 8 wherein said priority information is based one or more criteria selected from a group consisting of user preference, the protocol used by the remote server and one or more performance metrics.

10. A computing platform running software for aggregating file structures and files from a plurality of file servers, said software comprising:
a protocol framework module defining a set of core file access services and an interface for multiple protocol drivers to plug into a unified file access model; and
a data aggregation module providing multiplexing and de-multiplexing of services for file access and for constructing a virtual, unified file structure containing the file structure from one or more remote file servers and including a local file structure.

11. The computing platform of claim 8 wherein said software further comprises:
a data presentation module for presenting said virtual unified file structure to local users.

12. The computing platform of claim 11 wherein said software further comprises:
a user interface built on said data presentation module for customizing the local presentation of said virtual, unified file structure based on user preferences and the capabilities of said computing platform.

13. The computing platform of claim 10 wherein said software further comprises:
a data export service module for serving remote requests for access to said virtual, unified file structure.

14. The computing platform of claim 10 wherein said software further comprises one or more databases containing information about remote servers selected from a group consisting of access information, priority information and information relating to previous file accesses from the remote server.

15. A method, implemented by software running on a computing platform, for aggregating disparate file structures comprising the steps of:
accessing one or more remote file servers and aggregating the file structures of said file servers in to a virtual, unified file structure; and
including in said virtual, unified file structure, the local file structure of said computing platform.

16. The method of claim 15 further comprising the step of presenting, to a user on said computing platform, said virtual, unified file structure as a single structure of files.

17. The method of claim 15 further comprising the steps of:
receiving requests for manipulation to said virtual unified file structure or requests for access to files contained therein from user on said computing platform;
determining, based on which local or remote file servers need be accessed to fulfill said requests, the services required to fulfill said requests;
resolving semantic differences between said required services and the capabilities of the required file servers;
translating said required services into the native protocol of said servers; and
sending requests to the file servers.

18. The method of claim 17 further comprising the steps of:
receiving responses from said file servers; and
presenting results to said requesting user.

19. The method of claim 17 further comprising the step of retrieving, from a local database, access and priority information for any remote servers required to fulfill said requests.

20. The method of claim 15 further comprising the steps of:
serving, to remote requestors, said virtual unified file structure; and
fulfilling requests from remote requestors, for access to files contained therein.
